(19) United States
(12) Patent Application Publication
(10) Pub. No.: US 2016/0011663 A1
(43) Pub. Date: Jan. 14, 2016

(54) Motion-Sensed Mechanical Interface Features

(71) Applicant: Google Inc., Mountain View, CA (US)

(72) Inventors: Thad Eugene Starner, Mountain View, CA (US); Michael Patrick Johnson, Sunnyvale, CA (US)

(73) Assignee: Google Inc., Mountain View, CA (US)

(21) Appl. No.: 13/658,151

(22) Filed: Oct. 23, 2012

Related U.S. Application Data
(60) Provisional application No. 61/584,194, filed on Jan. 6, 2012.

(51) Int. Cl. G10K 11/18; G08B 6/00; G06F 3/02

(52) U.S. Cl. CPC G06F 3/016; G08B 6/00

(57) ABSTRACT

Embodiments may involve a computing device with a mechanical interface, such as a mechanical button or slider. The mechanical interface can be configured to generate, when actuated, vibration and/or acoustic signals having a characteristic pattern. The computing device can detect actuation of the mechanical interface by: receiving acoustic signal data generated by an acoustic sensing unit of the computing device; receiving vibration signal data generated by a vibration sensing unit of the computing device; and determining, based on a comparison of the acoustic and vibration signal data with the characteristic acoustic and vibration patterns, that the mechanical interface has been actuated.

### CROSS-REFERENCE TO RELATED APPLICATIONS

This patent application claims priority to U.S. Application No. 61/584,194, filed Jan. 6, 2012, the contents of which are entirely incorporated herein by reference, as if fully set forth in this application.

### BACKGROUND

Unless otherwise indicated herein, the materials described in this section are not prior art to the claims in this application and are not admitted to be prior art by inclusion in this section.

Keys of a keyboard, used to type text (letters or symbols), employ an electromechanical technique of detecting motion. Each key is a switch that is either on (typically when depressed) or off. Each letter or symbol that appears on a screen or a printed paper is a result of motion of the corresponding key and the corresponding switch being turned on. This simple binary code concept is at the heart of the digital age. However, these keys need to be hardwired to an electronic circuit which detects and converts the actuation of their corresponding switches into corresponding letters or symbols.

### SUMMARY

Disclosed herein are improved systems and devices having motion-sensed mechanical interface features.

In one embodiment, a computing device includes: (i) a mechanical interface unit, wherein the mechanical interface unit is configured to generate, when actuated, a vibration signal having a characteristic vibration pattern; (ii) a vibration sensing unit configured to detect vibration signals and to generate corresponding vibration signal data; and (iii) a processing unit configured to: (a) receive the vibration signal data; and (b) determine that the mechanical interface unit has been actuated based on a comparison of the received vibration signal data with the characteristic vibration pattern.

In another embodiment, a computer-implemented method involves: (a) receiving acoustic signal data generated by an acoustic sensing unit of a computing device; (b) receiving vibration signal data generated by a vibration sensing unit of the computing device, wherein the computing device comprises a mechanical interface unit that, when actuated, generates both an acoustic signal having a characteristic acoustic pattern and a vibration signal having a characteristic vibration pattern; and (c) determining, based on a comparison of the acoustic and vibration signal data with the characteristic acoustic and vibration patterns, that the mechanical interface unit has been actuated.

In a further embodiment, a non-transitory computer readable medium stores instructions that, when executed by one or more processors in a computing device, cause the computing device to perform operations including: (a) receiving acoustic signal data generated by an acoustic sensing unit of a computing device; (b) receiving vibration signal data generated by a vibration sensing unit of the computing device, wherein the computing device comprises a mechanical interface unit that, when actuated, generates both an acoustic signal having a characteristic acoustic pattern and a vibration signal having a characteristic vibration pattern; and (c) determining, based on a comparison of the acoustic and vibration signal data with the characteristic acoustic and vibration patterns, that the mechanical interface unit has been actuated.

These as well as other aspects, advantages, and alternatives will become apparent to those of ordinary skill in the art by reading the following detailed description, with reference where appropriate to the accompanying drawings. Further, it should be understood that this summary section and the rest of this document are intended to discuss the provided disclosure by way of example only and not by way of limitation.

### BRIEF DESCRIPTION OF THE DRAWINGS

FIG. 1 is a schematic diagram of one example embodiment of a computing system including a mechanical interface unit;

FIG. 2 is an example embodiment of a computing device having a plurality of mechanical interface units;

FIG. 3A is a cross-sectional view of an example embodiment of a mechanical interface unit;

FIG. 3B is an enhanced view of one example of ridges that can be employed in the mechanical interface unit shown in FIG. 3A;

FIG. 3C is an enhanced view of another example of ridges that can be employed in the mechanical interface unit shown in FIG. 3A;

FIG. 3D is an enhanced view of another example of ridges that can be employed in the mechanical interface unit shown in FIG. 3A;

FIG. 3E is an enhanced view of another example of ridges that can be employed in the mechanical interface unit shown in FIG. 3A;

FIGS. 4A and 4B are flow charts illustrating methods, according to example embodiments;

FIG. 5 illustrates example embodiments of computing devices equipped with mechanical interface units;

FIG. 6 illustrates a wearable computing system according to an example embodiment;

FIG. 7 illustrates an alternate view of the wearable computing device illustrated in FIG. 6;

FIG. 8 illustrates another wearable computing system according to an example embodiment;

FIG. 9 illustrates another wearable computing system according to an example embodiment; and

FIG. 10 illustrates a schematic drawing of a computing device according to an example embodiment.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

In an illustrative embodiment, a computing device includes a mechanical interface feature, such as a button or slider. When the mechanical interface feature is interacted with by a user, it is configured to generate a mechanical vibration that propagates in the housing and/or an acoustic vibration that propagates in the surrounding air, i.e., such as when subjected to a manual/physical pull or push. The illustrative computing device also includes a vibration or seismic sensor, and/or an acoustic sensor. The vibration sensor may be, for example an accelerometer and/or a gyroscope, which are arranged to sense vibration signals resulting from the actuation of the mechanical interface feature. The acoustic sensor may be, for example, a microphone, which is arranged to sense acoustic signals resulting from the actuation of the mechanical interface feature.

Configured as such, the mechanical interface may be non-electric; i.e., the interface may not have electrical components that directly generate a signal when the interface is actuated. For example, a mobile phone might include a physical button that contacts protruding ridges in a button well as it is being depressed into the well. As such, depressing the button such that it slides over the protruding ridges may cause the computing device itself to vibrate in a characteristic way and/or result in a characteristic clicking sound. The computing device may thus include one or more sensory systems that detect such characteristic vibration of the device, such characteristic clicking sound, or both. The computing device may therefore detect when the button is depressed by, e.g., detecting the characteristic device vibration, detecting the characteristic clicking sound, or detecting the combination of both.

A mechanical interface feature according to an example embodiment may be useful in various applications. For instance, the lack of any direct electrical connection to a mechanical feature, such as a button, may provide flexibility in the design of a device by allowing the feature to be placed in a location that is electrically isolated from a portion of the device that includes electric components. For example, a glasses-style head-mountable device (HMD) could include all electrical components on a right side arm (e.g., on the right side of the glasses' frame), and still include non-electric buttons according to an example embodiment on the left side arm (e.g., on the left side of the frame). Actuation of such non-electric buttons could be detected via audio and/or vibration sensors on the right side of the frame, without requiring any wiring between the right and left side of the HMD frame.

Further, mechanical interface features according to an example embodiment may be useful to improve reliability and durability in applications where similar electro-mechanical interface features have typically been used. For example, many touch-screen devices only have one or two mechanical buttons, which may be used heavily. Such heavily-used buttons may be susceptible to failure over time due to e.g., failure of electrical contacts and/or failure of electrical connections due to movement of electric components of the interface feature. However, actuation of an example mechanical interface feature may be detected by sensors that are not electrically connected to the feature. Thus, an example mechanical interface may be less susceptible to failure since there are no electrical components directly connected to movable parts of the feature.

Further, if wear and tear on an example mechanical interface feature changes its characteristics audio pattern and/or its characteristic vibration pattern, such that actuation is not being detected reliability, recalibration may be utilized so that the mechanical interface feature continues to function properly. For example, consider a configuration where a mobile phone includes a non-electric button that, when depressed, moves across ridge features and generates a characteristic clicking sound and/or causes a characteristic vibration of the mobile phone. Over time, as the ridge features and the button repeatedly rub against each other, the ridge features and/or the button itself may wear down, which in turn may change the audio pattern and/or the vibration pattern that results when the button is pressed. Accordingly, the phone may be configured to re-calibrate to adjust the characteristic audio pattern and/or the characteristic vibration pattern that are associated with the button.

The above embodiments and application are provided as examples and should not be construed as limiting. Many other embodiments are possible and will be understood to those skilled in the art upon reading the disclosure herein.

II. Illustrative Computing Devices with Mechanical Interfaces

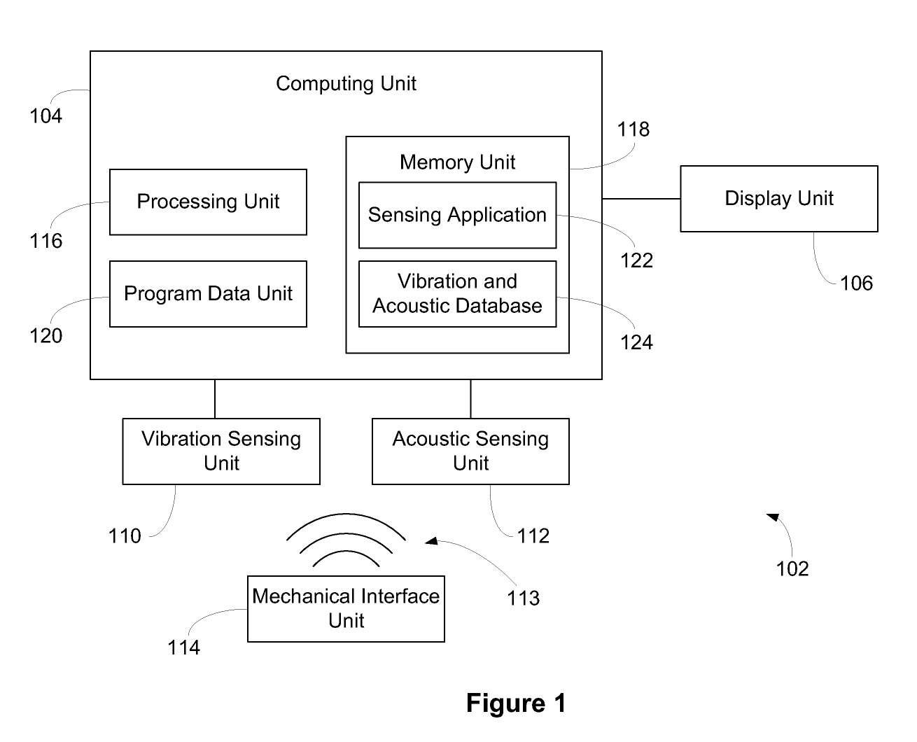

Now referring to FIG. 1, an example embodiment of a computing system 102 is illustrated. Computing system 102 includes a computing unit 104, a display unit 106, a vibration sensing unit 110, an acoustic sensing unit 112, and a mechanical interface unit 114. Computing unit 104 includes a processing unit 116, a memory unit 118, and a program data unit 120.

Memory unit 118 includes a sensing application 122, and vibration and acoustic signal database 124. Actuating the mechanical interface unit 114 (e.g., such as by a user input) generates vibration and/or acoustic signals 113 that can be detected via the vibration sensing unit 110 and/or acoustic sensing unit 112. Sensing application 122 is configured to convert vibration data and/or acoustic data provided to computing unit 104 by vibration sensing unit 110 and acoustic sensing unit 112 into corresponding commands to processing unit 116 (e.g., such as commands corresponding to a user input).

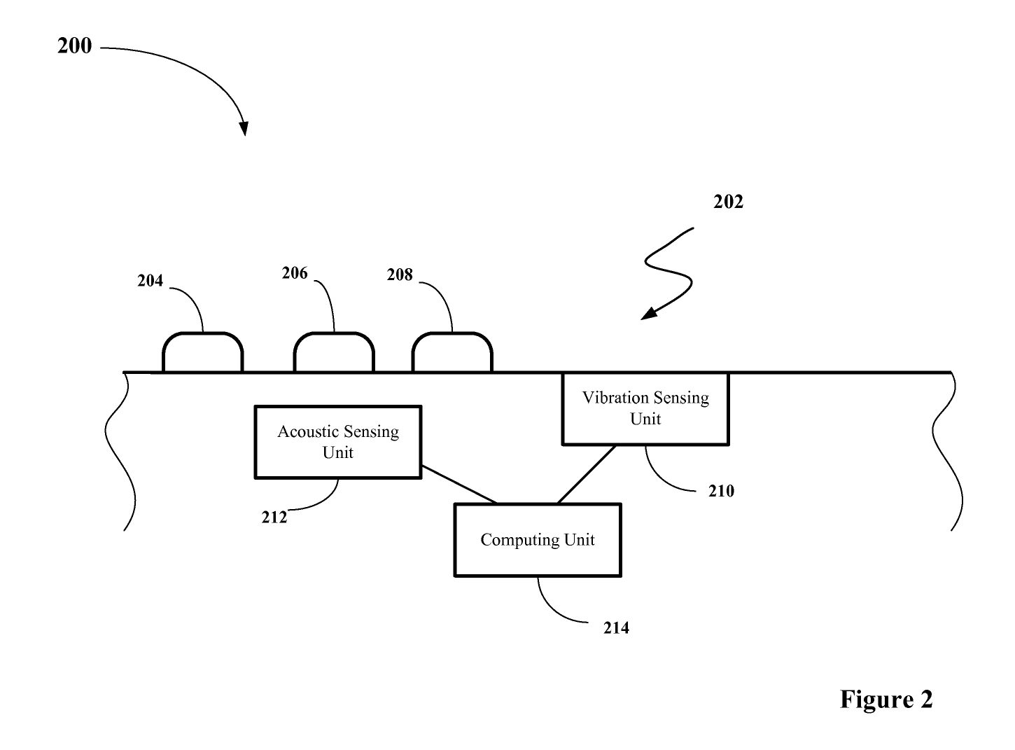

Now referring to FIG. 2, a schematic diagram illustrates an example embodiment 200 of a computing device 202. A plurality of mechanical interface units 204-208, a vibration sensing unit 210, and an acoustic sensing unit 212 are associated with computing device 202. As shown, mechanical interface units 204-208 are arranged on a surface of computing device 202, so as to be attached to a housing (not shown) of computing device 202. Mechanical interface units 204-208, which may not be connected electrically to computing unit 214, are each configured to generate corresponding vibration and acoustic signals when actuated, which propagate through the housing of the computing device 202 and the surrounding air. Vibration sensing unit 210 and acoustic sensing unit 212 are configured to detect the corresponding vibration signal and acoustic signal, respectively, and to provide data of the detected corresponding vibration and acoustic signals to computing unit 214.

Each of mechanical interface units 204-208 is configured to generate a vibration signal having a characteristic vibration signature or pattern and/or an acoustic signal having a characteristic acoustic signature or pattern when actuated. Information indicative of the characteristic vibration and/or acoustic patterns are pre-stored in program data unit 120. As such, computing unit 214 is configured to determine which one of mechanical interface units 204-208 has been actuated by comparing and/or correlating vibration and/or acoustic signal data received from vibration sensing unit 210 and/or acoustic sensing unit 212 with the pre-stored unique vibration and/or acoustic patterns.

The characteristic vibration and/or acoustic signal patterns may be stored in the form of Fourier Transform (FT) or Fast Fourier transform (FFT) data, for example. As such, upon receipt of vibration and acoustic signal data from vibration and acoustic sensing units 210 and 212, computing unit 214 can be configured to individually determine the FFT of both the vibration and acoustic signal data. The computing unit 214 can compare the FFT results to stored FFT data of characteristic vibration and acoustic signal patterns to determine which one of mechanical interface units 204-208 was actuated (i.e., which one of the mechanical interface units 204-208 generated the vibration and acoustic signal data detected with the vibration and acoustic sensing units 210, 212).

In order to have each of mechanical interface units 204-208 generate correspondingly identifiable vibration and acoustic signals, mechanical interface units 204-208 may be formed to generate mutually distinguishable vibration and acoustic signals. For example, the mechanical interface units 204-208 can have different sizes, can be located in different locations on computing device 202, can be made of different materials, and/or can have different vibration and/or acoustic signal generating components. In some embodiments, the vibration and acoustic signals generated by each of the mechanical interface units 204-208 can be substantially unique. Further, in addition to generating identifiable vibration and acoustic signals, each of mechanical interface units 204-208 may provide an identifiable tactile feedback to a user when actuated. Thus, such a user can operate the mechanical interface units 204-208 while relying on tactile feedback alone (e.g., without viewing the mechanical interface units 204-208) to distinguish between the different mechanical interface units 204-208.

In one embodiment, mechanical interface units 204-208 may be configured to generate acoustic signals outside a human-audible frequency range. Additionally or alternatively, mechanical interface units 204-208 may be configured to generate acoustic sounds that fall within a human-audible frequency range. Further, a vibration signal and an acoustic signal, generated by the same object or action, can be associated with different frequencies, (i.e., belong to non-overlapping frequency ranges).

Acoustic signals may travel in materials forming computing device 202, at a substantially faster speed than when travelling in surrounding air, and the amplitude of such signals may be preserved much better than when travelling through air. That is, an acoustic signal propagating through a solid material of the computing device 202, such as metal, plastic, etc., may experience relatively less amplitude degradation over a given propagation distance than an acoustic signal propagating through air over the same distance. As such, vibration sensor 210, which may be an accelerometer, may be able to detect the acoustic signals propagating through such material(s) forming computing device 202. Computing unit 214 may be configured to remove contributions from such acoustic signals from the vibration signal data after matching them to the related acoustic signals detected by acoustic sensing unit 212, so as to prevent the same generated acoustic signals from contributing to both the acoustic signal data and the vibration signal data in the process of determining which mechanical interface unit was actuated.

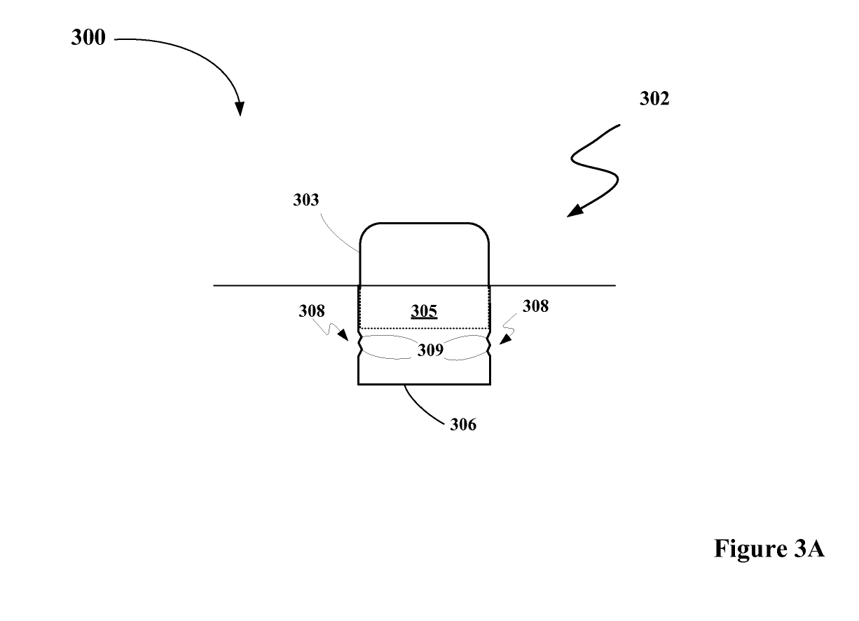

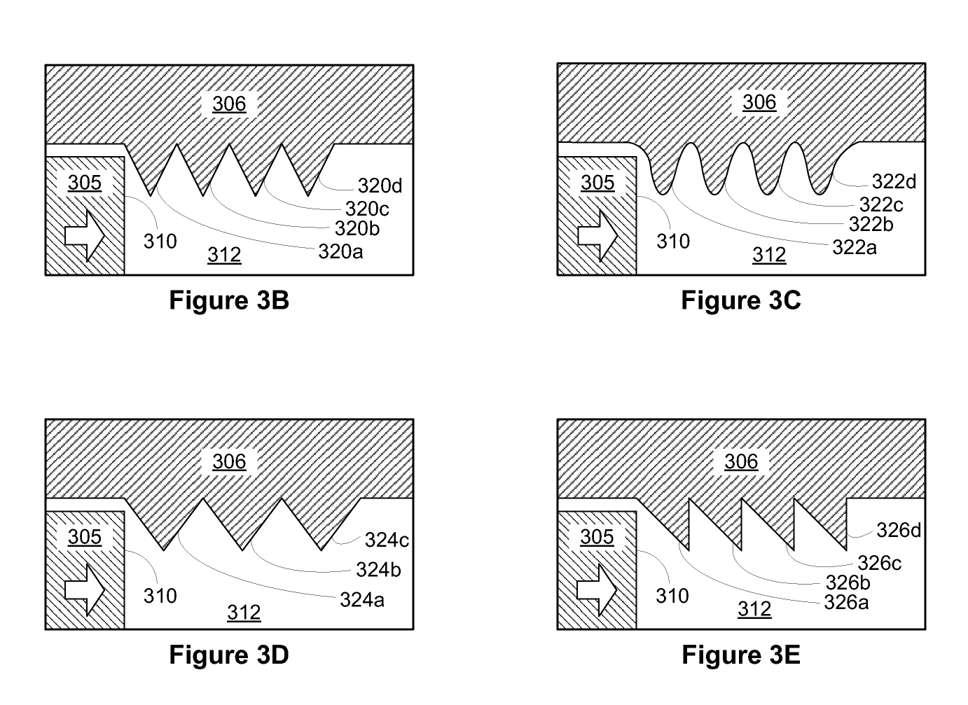

Now referring to FIG. 3A, a cross-section view of an example embodiment 300 of a mechanical interface unit 302 is shown. In this example embodiment, mechanical interface unit 302 includes an internal configuration that enables a generation of characteristic vibrations and/or sounds when interacted with. Mechanical interface unit 302 includes a movable component 303 and a recessed area (fixed component) 306. Movable component 303 includes a lower portion 305 that engages recessed area 306 below a surface of computing device 202. In one embodiment, recessed area 306 may include geometric features 308 configured to generate vibrations and sounds when an object moves past them while maintaining contact with them. In one embodiment, geometric features 308 include ridges 309. Examples of such ridges 309 are discussed in connection with FIGS. 3B-3E below.

As such, when mechanical interface unit 302 is actuated or depressed, lower portion 305 is pushed down into recessed area 306, and its walls are arranged to make contact with ridges 309 while passing past them, thereby generating identifiable vibration and/or acoustic signals. In some embodiments, the contact between the lower portion 305 and the ridges 309 can generate substantially unique vibration and/or acoustic signals. Vibration and acoustic sensing unit 210 and 212 are configured to detect the generated identifiable vibration and/or acoustic signals, and to provide corresponding vibration and/or acoustic signal data to computing unit 214, which in turn can be configured to associate the received vibration and/or acoustic signal data with a command (e.g., a user input, etc.).

Identifiable vibration and/or acoustic signals can be generated by interfacing the lower portion 305 of the mechanical interface unit 302 with patterns of ridges on the interior walls of the recessed area 306. or other physical geometric features configured to generate identifiable vibration and/or acoustic signals that propagate through the medium surrounding the mechanical interface unit 302 (e.g., to be detected at the acoustic sensing unit 212 and/or vibration sensing unit 210). FIGS. 3B through 3E illustrates example ridge patterns that can be employed to generate identifiable acoustic and/or vibration signals by interfacing with the lower portion 305 of the depressible button 302.

FIG. 3B is an enhanced view of one example of ridges 320a-d that can be employed in the mechanical interface unit 302 shown in FIG. 3A. The lower portion 305 is urged toward the cavity 312 formed by the interior walls of the recessed area 306, in the direction indicated by the arrow super-imposed on the lower portion 305 for illustrative purposes. A portion of a bottom surface 310 can interfere with each of the ridges 320a-d in turn to generate identifiable vibration and/or acoustic signals. For example, the side edge of the bottom surface 310 can interfere with the first ridge 320a, then the second ridge 320b, then the third ridge 320c, then the fourth ridge 320d. In some examples, a side surface of the lower portion 305 (e.g., the surface extending along the interior wall of the recessed area 306 also interferes (e.g., rubs) against the ridges 320a-d as the lower portion 305 is urged into the cavity 312,

FIG. 3C is an enhanced view of another example of ridges 322a-d that can be employed in the mechanical interface unit 302 shown in FIG. 3A. Similar to the discussion in connection with FIG. 3B above, the bottom surface 310 of the lower portion 305 interferes with the ridges 322a-d while it is urged into the cavity 312, and the interference generates identifiable vibration and/or acoustic signals. However, the vibration and/or acoustic signals generated by interference with the ridges 322a-d are distinguishable from the vibration and/or acoustic signals generated by interference with the ridges 320a-d due to the different shape of the two sets of ridges. For example, the pointed ridges 320a-d in FIG. 3B may generate relatively higher frequency vibration and/or acoustic signals than the rounded ridges 322a-d in FIG. 3C. Although other distinguishable characteristics may be present between the vibration and/or acoustic signals generated by the two sets of ridges 320a-d and 322a-d such that the vibration and/or acoustic signals detected by the vibration sensing unit 210 and/or acoustic sensing unit 212 can be used to distinguish between signals generated by the two different sets of ridges 320a-d and 322a-d.

FIG. 3D is an enhanced view of another example of ridges 324a-c that can be employed in the mechanical interface unit 302 shown in FIG. 3A. Similar to the discussion in connection with FIG. 3B above, the bottom surface 310 of the lower portion 305 interferes with the ridges 324a-c while it is urged into the cavity 312, and the interference generates identifiable vibration and/or acoustic signals. However, the vibration and/or acoustic signals generated by interference with the ridges 324a-c are distinguishable from the vibration and/or acoustic signals generated by interference with the ridges 320a-d due to the different number and/or spacing of the ridges 324a-c compared to the ridges 320a-d. For example, vibration and/or acoustic signals generated due to interference with the three ridges 324a-c can be distinguishable from vibration and/or acoustic signals generated due to interference with the four ridges 320a-d. Moreover, in some embodiments, the two sets of ridges can be spaced differently such that the vibration and/or acoustic signals generated by the two sets of ridges 320a-d and 324a-c are characteristically different for a given speed of the lower portion 305.

FIG. 3E is an enhanced view of another example of ridges 326a-d that can be employed in the mechanical interface unit 302 shown in FIG. 3A. Similar to the discussion in connection with FIG. 3B above, the bottom surface 310 of the lower portion 305 interferes with the ridges 326a-d while it is urged into the cavity 312, and the interference generates identifiable vibration and/or acoustic signals. However, the vibration and/or acoustic signals generated by interference with the ridges 326a-d are distinguishable from the vibration and/or acoustic signals generated by interference with the ridges 320a-d due to the different shape and/or spacing of the ridges 326a-d compared to the ridges 320a-d. Furthermore, the sawtooth-shaped ridges 326a-d are shaped asymmetrically with respect to the direction of motion of the lower portion 305. That is, the bottom surface 310 is exposed to a sloped face (compliant face) of the sawtooth-shaped ridges 326a-d when urged in the direction indicated by the super-imposed arrow (e.g., moving into the cavity 312), but is exposed to a transverse face (non-compliant face) when returning in the opposite direction (e.g., moving out of the cavity 312). The vibration and/or acoustic signals generated by interference between the movable portion and the asymmetrically shaped ridges 326a-d moving in one direction can thus be distinguishable from signals generated by interference moving in the opposite direction. In some embodiments, asymmetric ridges can be employed to enable distinguishing one direction of motion of the lower portion 305 from another.

Moreover, this type of vibration-based and/or acoustic-based sensing of actuations of mechanical interface units may allow an example computing device to distinguish between depressing a mechanical interface unit, and releasing the mechanical interface unit to let it return to its original position. For example, a button 302 including the lower portion 305 can be elastically biased outward from a housing, and upon depressing the button, the lower portion 305 of the button can interface with the sawtooth-shaped ridges 326a-d by moving past them in a first direction (e.g., as indicated by the directional arrow on the lower portion 305 in FIG. 3E). Upon releasing the depressed button (or by decreasing the force on the button), the lower portion 305 moves back to its original position and drags past the sawtooth-shaped ridges 326a-d in the opposite direction. Because the sawtooth-shaped ridges 326a-d are not symmetric about their respective peak points, they present a different interference to the movable part depending on the direction of motion, and as a result generate distinguishable vibration and/or acoustic sounds depending on the direction of motion of the lower portion 305. The sawtooth-shaped ridges 326a-d are provided for illustrative purposes, but other ridges shaped to be asymmetric with respect to the direction of motion of the lower portion 305 can also generate distinguishable vibration and/or acoustic signals depending on the direction of motion of the lower portion 305. Moreover, patterns of ridges can be created with direction-dependence, such as by adjusting the spacing between adjacent ridges non-uniformly across a pattern of ridges, etc.

Accordingly, an example computing device may associate different actions or commands with depressing a button of a mechanical interface unit and releasing the same button. As such, mechanical interface unit 302 may be configured to generate first vibration and acoustic signals when movable component 303 is moved from a first position to a second position, and to generate distinct second vibration and acoustic signals when movable component 303 is moved back from the second position to the first position. As a specific example, a mechanical interface unit may include or take the form of a button. The button may be configured, when depressed, to generate an acoustic signal having a first characteristic acoustic pattern and/or a vibration signal having a first characteristic vibration pattern. Further, the button may be configured, when released after being depressed, to generate an acoustic signal having a second characteristic acoustic pattern and/or a vibration signal having a second characteristic vibration pattern. Accordingly, in response to detecting that acoustic signal data and/or vibration signal data substantially match a respective predetermined power spectrum corresponding to the first characteristic acoustic pattern and/or the first characteristic vibration pattern, the computing device may generate a first control signal, which may initiate an action that corresponds to the button being depressed. Further, in response to detecting that acoustic signal data and/or vibration signal data substantially match a respective predetermined power spectrum corresponding to the second characteristic acoustic pattern and/or the second characteristic vibration pattern, the computing device may generate a second control signal, which may initiate an action that corresponds to the button being released.

As discussed above, in one embodiment, when the computing device includes a plurality of mechanical interface units, computing unit 214 may be configured to apply FTs or FFTs to the stored vibration and/or acoustic patterns, and to apply FTs or FFTs to the received corresponding vibration and/or acoustic signal data. Computing unit 214 can be configured to use a running spectrogram of small window overlapping FFT's and then compare the spectrograms in a time-normalized manner (e.g., using Dynamic Time Warping (DTW) or using a Hidden Markov Modeling (HMM)), so as to determine which one of the plurality of mechanical interface units was actuated. For example, computing unit 214 can be configured to compare power spectra of the evaluated FFTs of the received corresponding vibration and acoustic signal data, which may be sampled in overlapping windows of time, to the stored FFTs of the vibration and acoustic patterns. The time windows may have a time length of 20 milliseconds (ms) with 10 ms overlaps, or a length of 5 ms with 2.5 ms overlaps. Alternatively, any other suitable window time lengths and overlaps may be used. Selections of suitable window time lengths and overlaps may depend on the sound and vibration characteristics (e.g., qualities) of the mechanical interface units.

Moreover, as stated above, frequencies of the received corresponding vibration and acoustic signal data may be grouped into frequency bins to create feature vectors. In one embodiment, a feature vector may include 40 components, for example. In order to combine the features of the received corresponding vibration and acoustic signal data, the vibration signal frequencies are populated in frequency bins between 1 Hz and 20 Hz, and the acoustic signal frequencies are populated in frequency bins between 20 Hz to 48000 Hz. Alternatively, any other frequency bins for the vibration signal frequencies and the acoustic signal frequencies may be populated. In another embodiment, the higher frequencies may be grouped together in larger frequency bins in a logarithmic fashion, e.g., 1-2 Hz, 2-4 Hz, 4-8 Hz, 8-14 Hz, 14-20 Hz, 20-40 Hz, 40-100 Hz, 100-200 Hz, etc.

In one embodiment, when the mechanical interface units are configured to generate corresponding short and consistent vibration and acoustic signals when actuated, computing unit 214 is configured to compare the evaluated FFTs of the received corresponding vibration and acoustic signal data against the stored FFTs of the vibration and acoustic patterns by performing a Euclidean distance template matching. Alternatively, computing unit 214 may be configured to perform the comparison via a dynamic time warping comparison.

In another embodiment, vibration and acoustic sensing units 210 and 212 provide both of their respective vibration and acoustic signal data to computing unit 214, which is configured to apply FFTs to the vibration and to the acoustic signals, separately. Subsequently, computing unit 214 is configured to combine the resulting FFTs. As vibration signals can be sampled at lower frequencies than those of the acoustic signals, FFT bands of vibration signals are in lower frequencies than those of the acoustic signals. As such, the combination of resulting FFTs may lead to FFTs of vibration signals filling in low bands of frequencies while FFTs of acoustic signals filling in higher bands of frequencies.

In another embodiment, in case the frequency bands between vibration signals and acoustic signals overlap in some frequency band, a measurement of correlation or spectral coherence might be used to ensure that the received vibration and acoustic signals received by each vibration and acoustic sensing units 210 and 212 are from the same original source. This measurement can help eliminate false positives in just the vibrational or acoustic components since mechanical interface units generate both signals and these signals are expected to be spectrally coherent in overlapping frequency bands.

In some embodiments, the frequency and/or phase information of the received vibration and/or acoustic signals data can be analyzed to identify distinguishable characteristics associated with actuation of one or more mechanical interface units. For example, power spectra of received signals can be determined and compared with power spectra associated with actuation of one or more mechanical interface units. Additionally or alternatively, the phase of received vibration and/or acoustic signal data can be characterized and compared with phase information associated with actuation of one or more mechanical interface units. Additionally or alternatively, the frequency of received vibration and/or acoustic signal data can be characterized and compared with frequency information associated with actuation of one or more mechanical interface units. In some embodiments, the characterization of such frequency and/or phase attributes of received vibration and/or acoustic signal data can include characterizing any temporal variation in such parameters.

In some embodiments, the computing unit 214 can be configured to compare received vibration and/or acoustic signal data with stored vibration and/or acoustic characteristic patterns by processing the received data with one or more matched filters. For example, a matched filter bank can be used to determine a correspondence between the received vibration and/or acoustic data and a particular signal associated with the matched filter(s) (e.g. the stored vibration and/or acoustic characteristic patterns). In some examples, the computing unit 214 can be configured to associate an output from such a matched filter that exceeds a threshold value with actuation of a mechanical interface unit that generates a characteristic vibration and/or acoustic pattern associated with the matched filter. In this way, a bank of matched filters can be employed with each matched filter tuned to respond to vibration and/or acoustic signals generated by different mechanical interface units, and actuation of different mechanical interface units can thereby be distinguished.

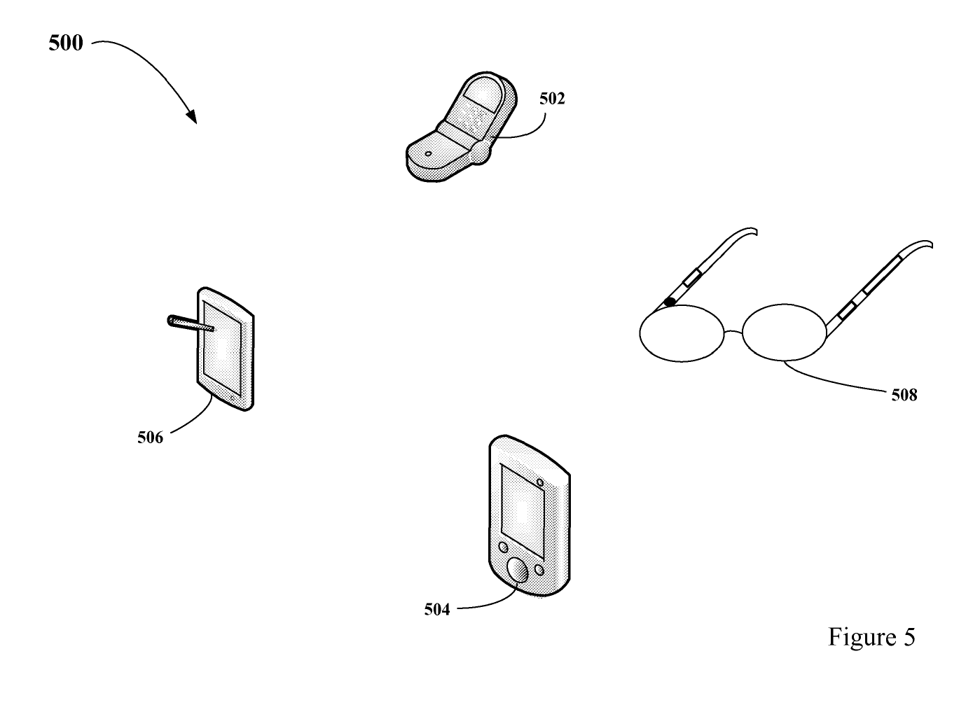

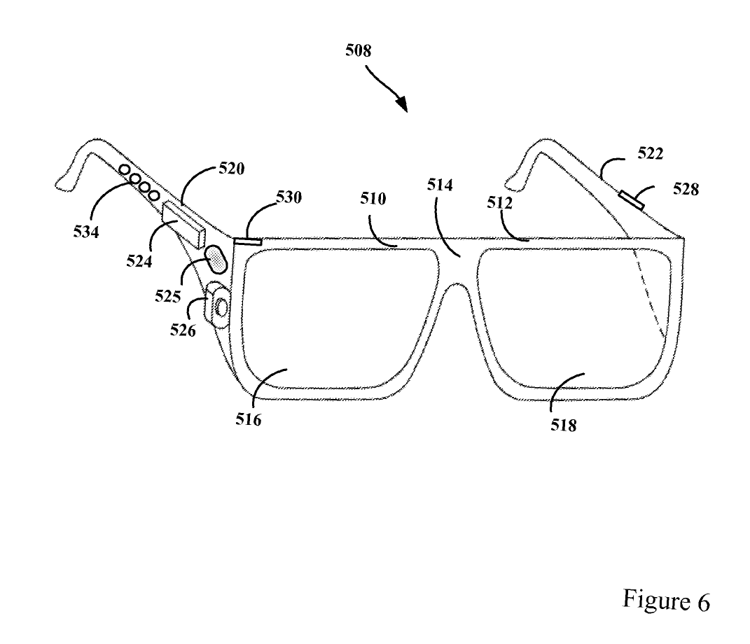

A mechanical interface according to an example embodiment may be implemented in various types of computing devices. For example, as shown in FIG. 5, a computing device, such as computing device 102, 202, or 320, may be one of a group of small-form factor example computing devices 500. For example, such small form factor computing devices 500 can be portable (or mobile) electronic device such as a cell phone 502, a personal data assistant (PDA) 504, a tablet or notebook 506, a personal media player device (not shown), a personal headset device (not shown), or a hybrid device that includes any of the above functions. In one embodiment, computing device 102, 202, or 320 may be a head wearable display device 508. These computing devices 502-508 may include mechanical interface units (not shown) distributed on their respective housings or supporting frames.

In the case of cell phone 502, for example, wireless mechanical interface units may be substituted for keys of a keypad, which are electronically connected to internal electronic circuitry (not shown). Cell phone 502 may be configured additional components (not shown), such an accelerometer, a gyroscope, and a microphone. In case of a head wearable display device 508, described further in the discussion of FIG. 6, wireless mechanical interface units may be positioned on extending side-arms connected to a central support frame.

In a further aspect, a computing device may implement a recalibration process to recalibrate a mechanical interface feature according to an example embodiment. Specifically, there may be scenarios where the sound and/or vibration of the device that result from actuating a mechanical feature change over time as a result of wear and tear and/or for other reasons. For example, referring to FIG. 3A, ridges 309 and/or the sides of lower portion 305 may wear down over time as the movable component 303 is repeatedly pressed, causing ridges 309 and/or the sides of lower portion 305 to repeatedly rub against each other. Thus, repeated use may change the audio pattern and/or the vibration pattern that results when the movable component 303 (“button”) of mechanical interface unit 302 is pressed. Accordingly, a computing device in which mechanical interface unit 302 is implemented may be configured to re-calibrate to adjust the characteristic audio pattern and/or the characteristic vibration pattern that are associated with the actuation of mechanical interface unit 302.

In some embodiments, a computing device may automatically recalibrate a mechanical interface unit 302. For example, the computing device could detect drift in the audio and/or vibration patterns generated by pressing movable component 303 and responsively adjust the characteristic audio and/or vibration patterns that are associated with mechanical interface unit 302 to compensate for the drift.

Additionally or alternatively, a computing device could provide for user-assisted calibration. For instance, an application may allow a user to indicate to the computing device that a mechanical interface feature is not working properly and/or request recalibration. The computing device may then prompt the user to actuate the mechanical interface feature a number of times by, for example, playing a certain sound and/or flashing a certain graphic on its display to indicate when the user should actuate the feature. The computing device may thus measure the audio and/or vibration data received at its sensors at the times when the user is instructed to to actuate the feature, and set the characteristic audio and/or vibration patterns based on the measured data. Other calibration processes are also possible.

The above examples of computing devices are provided for illustrative purposes, and are not intended to be limiting. Other types of computing devices may incorporate a mechanical interface, without departing from the scope of the invention.

### III. Illustrative Methods for Detecting Actuation of a Mechanical Interface

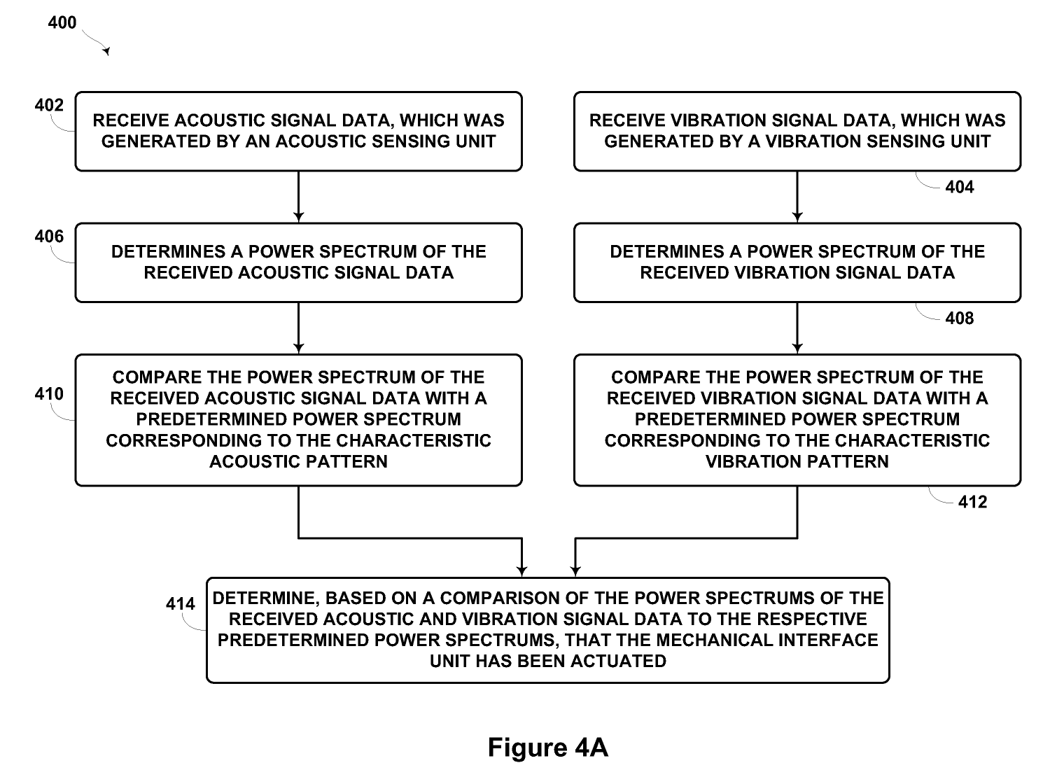

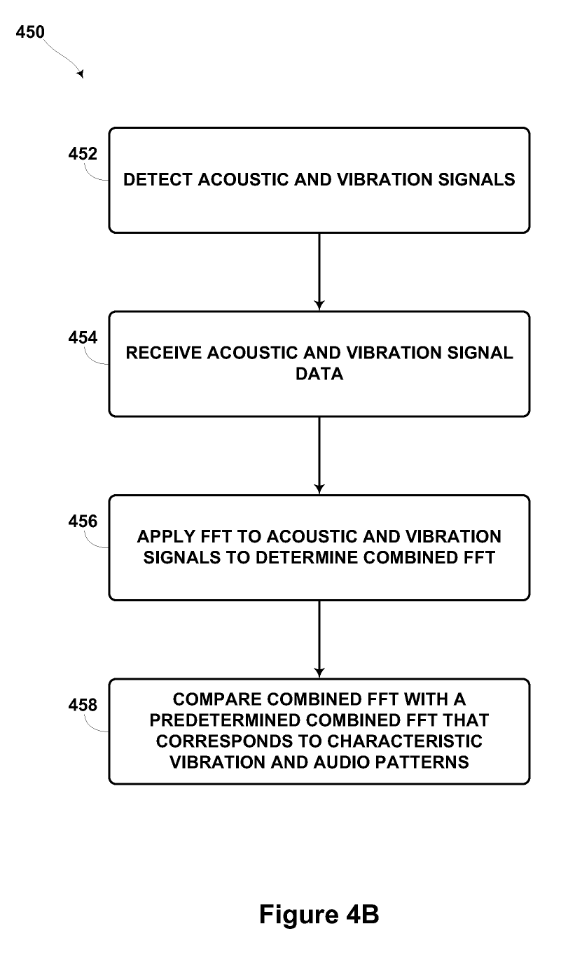

FIGS. 4A and 4B are flow chart illustrating methods 400 and 450, according to example embodiments. Methods 400 and 450 may be implemented by a computing device to detect vibration of the device and/or sounds that are characteristic of a mechanical interface being actuated.

Referring to FIG. 4A, at block 402, a computing device may receive acoustic signal data, which was generated by an acoustic sensing unit of the computing device. The computing device also receives vibration signal data, which was generated by a vibration sensing unit of the computing device, as shown by block 404. Further, the computing device determines a power spectrum of the received acoustic signal data, as shown by block 406, and determines a power spectrum of the received vibration signal data, as shown by block 408. At block 410, the computing device compares the power spectrum of the received acoustic signal data with a predetermined power spectrum corresponding to the characteristic acoustic pattern. At block 412, the computing device compares the power spectrum of the received vibration signal data with a predetermined power spectrum corresponding to the characteristic vibration pattern. Then, at block 414, the computing device may determine, based on a comparison of the power spectra of the received acoustic and vibration signal data to the respective predetermined power spectra, that the mechanical interface unit has been actuated.

Note that in method 400, actuation of a mechanical interface may be detected when both the vibration of the computing device and the acoustic signal match the characteristic vibration pattern and the characteristic acoustic pattern, respectively. However, in some embodiments, actuation of a mechanical interface may be detected based on analysis of an acoustic signal, without requiring additional analysis of a vibration signal. Further, in other embodiments, actuation of a mechanical interface may be detected based on analysis of a vibration signal, without requiring additional analysis of an acoustic signal.

In a further aspect of some embodiments, the computing device may separately: (a) compare the power spectrum of the acoustic signal to a predetermined power spectrum corresponding to the characteristic acoustic pattern and (b) compare the power spectrum of the vibration signal to a predetermined power spectrum corresponding to the characteristic vibration pattern. However, in other embodiments, the computing device may combine the power spectra and compared the combined power spectra to a predetermine power spectrum that corresponds to both the characteristic acoustic pattern and the characteristic vibration pattern. FIG. 4B provides an example of such an embodiment.

More specifically, at block 452 of method 450, acoustic and vibration sensing units 210 and 212 detect acoustic and vibration signals resulting from the actuation of one of the plurality of mechanical interface units 204-208. Computing unit 214 is configured to receive data corresponding to the detected acoustic and vibration signals, at block 454. Subsequently, computing unit 214 is configured to apply an FFT to each of the two signal data, and to combine the resulting FFTs, at block 456. Then, computing unit 214 is configured to compare the resulting combined FFT with a predetermined combined FFT that corresponds to the characteristic acoustic and vibration signal patterns of mechanical interface units 204-208, in order to determine which one of mechanical interface units 204-208 was actuated, at block 458.

In an example embodiment, the acoustic signal and vibration signal may be sampled at different frequencies. For instance, vibration signal data may be obtained by sampling the signal from an accelerometer, while the acoustic signal data may be obtained by sampling the signal from a microphone. Further, since the vibration of the device that is detected by the accelerometer may typically be at a lower frequency than the sound detected by the microphone, the accelerometer may be sampled at a lower frequency than the microphone. Accordingly, the FFT of the vibration signal data may be in a lower frequency band than the FFT of the acoustic signal data. Accordingly, both FFTs may be combined, with the FFT of the vibration signal providing the lower frequencies, and the FFT of the acoustic signal providing the higher frequencies in the combined FFT.

In some embodiments, it may be assumed that the vibration signal from, e.g., an accelerometer, and the acoustic signal from, e.g., a microphone, are spectrally coherent with each other in any overlapping frequency bands. However, in some embodiments, the computing device may determine a measure of correlation (e.g., spectral coherence) between the vibration signal and the acoustic signal. The measure of correlation may then be used to help isolate the audio and/or vibrational component of the signal from the microphone and accelerometer, respectively.

### IV. Illustrative Head-Mountable Device Systems and Architecture

FIG. 6 illustrates a head wearable computing system according to an example embodiment. In FIG. 6, the wearable computing system takes the form of a head-mountable device (HMD) 508 (which may also be referred to as a head-mountable display). It should be understood, however, that example systems and devices may take the form of or be implemented within or in association with other types of devices, without departing from the scope of the invention. As illustrated in FIG. 5, head-mountable device 508 comprises frame elements including lens-frames 510, 512 and a center frame support 514, lens elements 516, 518, and extending side-arms 520, 522. Center frame support 514 and extending side-arms 520, 52 are configured to secure head-mountable device 508 to a user's face via a user's nose and ears, respectively.

Each of the frame elements 510-514 and extending side-arms 520, 522 may be formed of a solid structure of plastic and/or metal, or may be formed of a hollow structure of similar material so as to allow wiring and component interconnects to be internally routed through the head-mountable device 508. Other materials may be possible as well.

One or more of each of the lens elements 516, 518 may be formed of any material that can suitably display a projected image or graphic. Each of the lens elements 516, 518 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 520, 522 may each be projections that extend away from the lens-frames 510, 512, respectively, and may be positioned behind a user's ears to secure the head-mountable device 508 to the user. The extending side-arms 520, 522 may further secure the head-mountable device 508 to the user by extending around a rear portion of the user's head. Additionally or alternatively, for example, the HMD 508 may connect to or be affixed within a head-mountable helmet structure. Other possibilities exist as well.

HMD 508 may also include an on-board computing system 524, a video camera 526, a vibration sensor 528, an acoustic sensor 530, a finger-operable touch pad 532, and wireless mechanical interface units 534. On-board computing system 524 is shown to be positioned on extending side-arm 520 of head-mountable device 508; however, on-board computing system 524 may be provided on other parts of head-mountable device 508 or may be positioned remote from head-mountable device 508 (e.g., on-board computing system 524 could be wire- or wirelessly connected to head-mountable device 508). On-board computing system 518 may include a computing unit (not shown) that includes a processor (not shown) and a memory (not shown), for example. On-board computing system 524 may be configured to receive and analyze data from video camera 526 and the finger-operable touch pad 525 (and possibly from other sensory devices, user interfaces, or both) and generate images for output by the lens elements 516 and 518.

Video camera 526 is shown positioned on the extending side-arm 520 of head-mountable device 508; however, video camera 526 may be provided on other parts of the head-mountable head-mountable device 502. Video camera 526 may be configured to capture images at various resolutions or at different frame rates. Many video cameras with a small form-factor, such as those used in cell phones or webcams, for example, may be incorporated into an example of the HMD 508.

Further, although FIG. 6 illustrates one video camera 526, more video cameras may be used, and each may be configured to capture the same view, or to capture different views. For example, video camera 526 may be forward facing to capture at least a portion of the real-world view perceived by the user. This forward facing image captured by video camera 526 may then be used to generate an augmented reality where computer generated images appear interact with the real-world view perceived by the user.

Vibration sensor 528 is shown on extending side-arm 522 of head-mountable device 508; however, vibration sensor 528 may be positioned on other parts of head-mountable device 508. Vibration sensor 528 may include one or more of a gyroscope or an accelerometer, for example. Acoustic sensor 530 is shown on lens frame 510 of head-mountable device 508; however, acoustic sensor 530 may be positioned on other parts of head-mountable device 508. Acoustic sensor 528 may include a microphone, for example. Other sensing devices may be included within, or in addition to, vibration sensor 522 and acoustic sensor 530 or other sensing functions may be performed by vibration sensor 522 and acoustic sensor 530.

Mechanical interface units 534 are shown positioned on extending side-arms 520; however, mechanical interface units 534 may be positioned on other parts of head-mountable device 508. Vibration and acoustic signals, generated by actuation of mechanical interface units 534, are detected by vibration sensor 528 and acoustic sensor 530, respectively, and their corresponding signal data is communicated to computing system 524. Additionally, mechanical interface units 534, each of which is correlated to a respective function or command, may be positioned on different parts of head-mountable device 508 to facilitate sorting or identifying them based on their respective locations.

Finger-operable touch pad 525 is shown on the extending side-arm 520 of the head-mountable device 508. However, finger-operable touch pad 525 may be positioned on other parts of the head-mountable device 508. Also, more than one finger-operable touch pad may be present on the head-mountable device 508. Finger-operable touch pad 525 may be used by a user to input commands. Finger-operable touch pad 525 may sense at least one of a position and a movement of a finger via capacitive sensing, resistance sensing, or a surface acoustic wave process, among other possibilities. Finger-operable touch pad 525 may be capable of sensing finger movement in a direction parallel or planar to the pad surface, in a direction normal to the pad surface, or both, and may also be capable of sensing a level of pressure applied to the pad surface. Finger-operable touch pad 525 may be formed of one or more translucent or transparent insulating layers and one or more translucent or transparent conducting layers. Edges of finger-operable touch pad 525 may be formed to have a raised, indented, or roughened surface, so as to provide tactile feedback to a user when the user's finger reaches the edge, or other area, of finger-operable touch pad 525. If more than one finger-operable touch pad is present, each finger-operable touch pad may be operated independently, and may provide a different function.

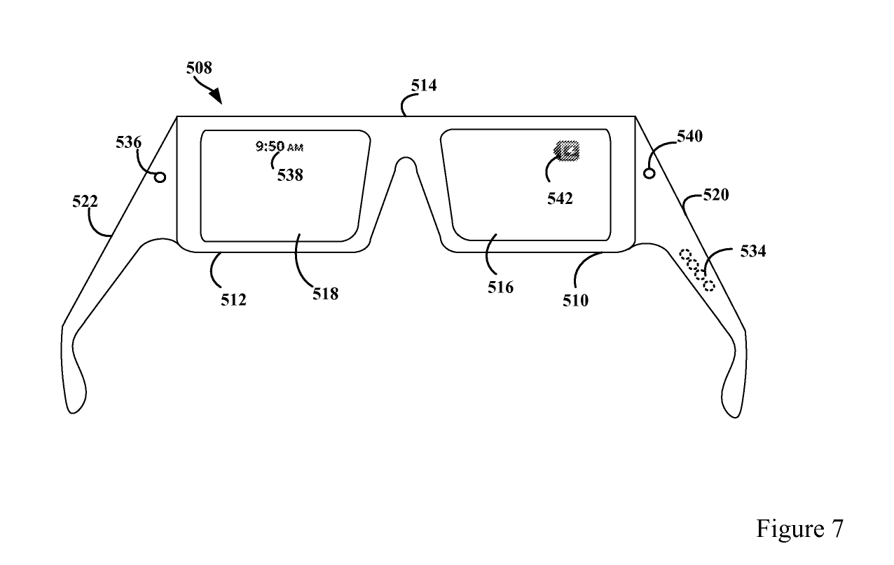

FIG. 7 illustrates an alternate view of the wearable computing device illustrated in FIG. 6. As shown in FIG. 7, lens elements 516, 518 may act as display elements. Head-mountable device 508 may include a first projector 536 coupled to an inside surface of extending side-arm 522 and configured to project a display 538 onto an inside surface of lens element 518. Additionally or alternatively, a second projector 540 may be coupled to an inside surface of extending side-arm 520 and configured to project a display 542 onto an inside surface of lens element 516.

Lens elements 516, 518 may act as a combiner in a light projection system and may include a coating that reflects the light projected onto them from projectors 538, 540. In some embodiments, a reflective coating may not be used (e.g., when projectors 538, 540 are scanning laser devices).

In alternative embodiments, other types of display elements may also be used. For example, lens elements 510, 518 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 510, 512 for driving such a matrix display. Alternatively or additionally, a laser or LED source and scanning system could be used to draw a raster display directly onto the retina of one or more of the user's eyes. Other possibilities exist as well.

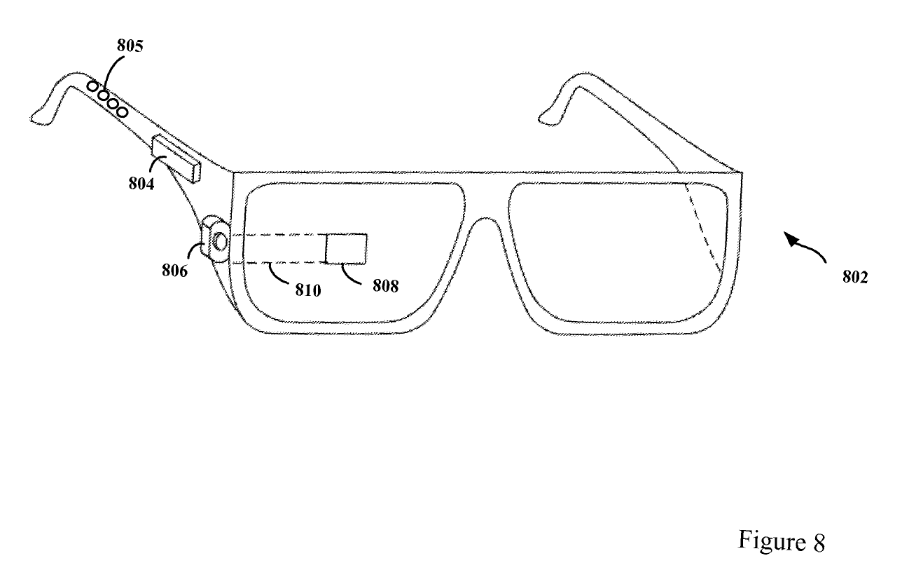

FIG. 8 illustrates another wearable computing system according to an example embodiment, which takes the form of an HMD 802. HMD 802 may include frame elements and side-arms such as those described with respect to FIGS. 6 and 7. HMD 802 may additionally include an on-board computing system 804, a plurality of mechanical interface units 805, and a video camera 806, such as those described with respect to FIGS. 6 and 7. Video camera 806 is shown mounted on a frame of the HMD 802. However, video camera 806 may be mounted at other positions as well.

As shown in FIG. 8, HMD 802 may include a single display 808 which may be coupled to the device. Display 808 may be formed on one of the lens elements of HMD 802, such as a lens element described with respect to FIGS. 6 and 7, and may be configured to overlay computer-generated graphics in the user's view of the physical world. Display 808 is shown to be provided in a center of a lens of HMD 802; however, display 808 may be provided in other positions. Display 808 is controllable via computing system 804 that is coupled to display 808 via an optical waveguide 810.

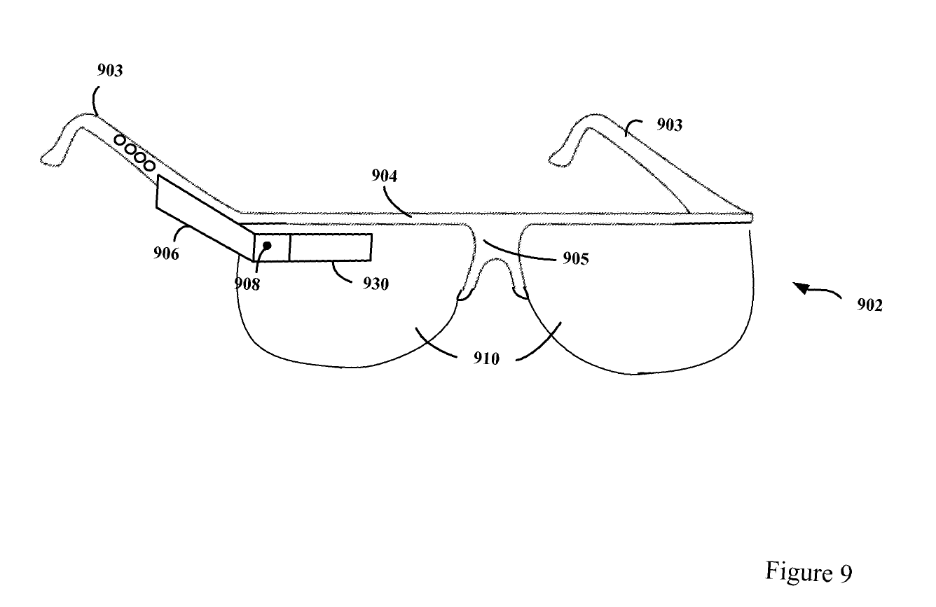

FIG. 9 illustrates another wearable computing system according to an example embodiment, which takes the form of an HMD 902. HMD 902 may include side-arms 903, a center frame support 904, and a bridge portion with nosepiece 905. In the example shown in FIG. 8, center frame support 804 connects side-arms 903. HMD 902 may additionally include an on-board computing system 906 and a video camera 908, such as those described with respect to FIGS. 6 and 7.

HMD 902 may include lens elements 910, each of which may be coupled to one of side-arms 903 or center frame support 904. Lens element 910 may include a display such as the display described with reference to FIGS. 6 and 7, and may be configured to overlay computer-generated graphics upon the user's view of the physical world. In one example, lens elements 910 may be coupled to the inner side (i.e., the side exposed to a portion of a user's head when worn by the user) of corresponding extending side-arms 903. Lens elements 910 may be positioned in front of or proximate to a user's eye when HMD 902 is worn by a user. For example, lens elements 910 may be positioned below center frame support 904, as shown in FIG. 9.

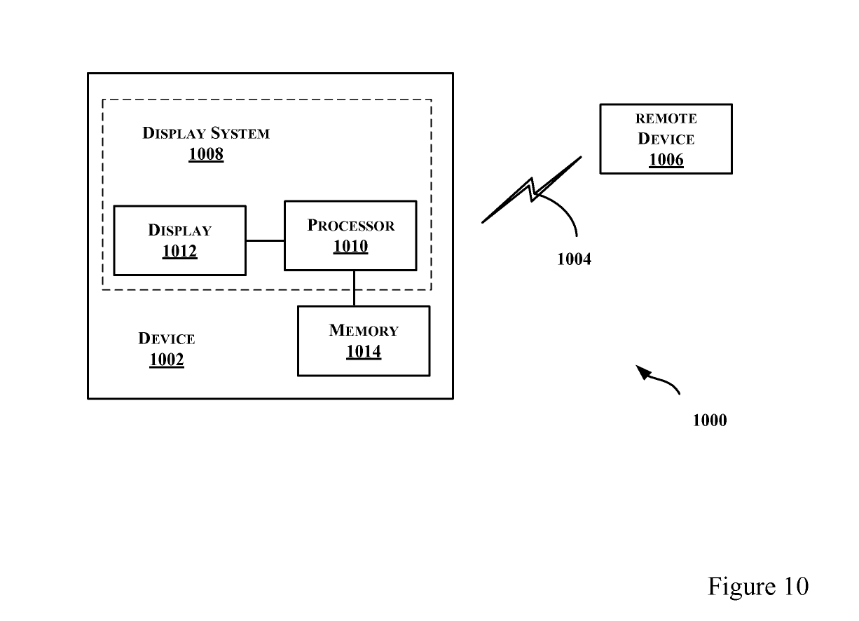

FIG. 10 illustrates a simplified block diagram of an example computer-network infrastructure. In one system 1000, a device 1002 communicates using a communication link 1004 (e.g., a wired or wireless connection) to a remote device 1006. Device 1002 may be any type of device that can receive data and display information corresponding to or associated with the data. For example, device 1002 may be a heads-up display system, such as the head-mountable devices 502, 802, or 902 described with reference to FIGS. 6-9.

Thus, device 1002 may include display system 1008 comprising a processor 1010 and a display 1012. Display 1012 may be, for example, an optical see-through display, an optical see-around display, or a video see-through display. Processor 1010 may by any type of processor, such as a microprocessor or a digital signal processor, for example. Device 1002 may further include on-board data storage, such as memory 1014 coupled to processor 1010. Memory 1014 may store software that can be accessed and executed by processor 1010, for example.

Remote device 1006 may be any type of computing device or transmitter including a laptop computer, a mobile telephone, a network server, etc., that is configured to transmit data to device 1002. Remote device 1006 and device 1002 may contain hardware to enable communication link 1004, such as processors, transmitters, receivers, antennas, etc.

In FIG. 10, communication link 1004 is illustrated as a wireless connection; however, wired connections may also be used. For example, communication link 1004 may be a wired link via a serial bus such as a universal serial bus or a parallel bus. Such a wired connection may be a proprietary connection as well. Communication link 1004 may also be a wireless connection that uses, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. Remote device 1006 may be accessible via the Internet and may comprise a computing cluster associated with a particular web service (e.g., social-networking, photo sharing, address book, etc.).

Depending on the desired configuration, processor 1010 can be any type of processor including, but not limited to, a microprocessor ( )lP), a microcontroller ( )lC), a digital signal processor (DSP), or any combination thereof. Furthermore, system memory 258 can be of any type of memory now known or later developed including but not limited to volatile memory (such as RAM), non-volatile memory (such as ROM, flash memory, etc.) or any combination thereof.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

1. A computing device comprising:
a mechanical interface unit arranged on the computing device, wherein the mechanical interface unit comprises a movable button that is configured to generate, when depressed actuated, a vibration signal that propagates through at least one component of the computing device with a characteristic vibration pattern, wherein the button is non-electric and is arranged on the computing device at a location that is electrically isolated;
a vibration sensing unit configured to detect vibration signals and to generate corresponding vibration signal data; and
a processing unit configured to:
receive the vibration signal data; and
determine that the button has been depressed based on a comparison of the received vibration signal data with the characteristic vibration pattern generated when the button is depressed.

2. The computing device of claim 1, wherein the button is further configured to generate, when depressed, an acoustic signal having a characteristic acoustic pattern, the computing device further comprising:
an acoustic sensing unit configured to detect the acoustic signal and to generate corresponding acoustic signal data;
wherein the processing unit is further configured to:
receive the acoustic signal data;
determine that the button has been depressed based on both: (i) a comparison of the received acoustic signal data with the characteristic acoustic pattern, and (ii) the comparison of the received vibration signal data with the characteristic vibration pattern.

3. The computing device of claim 1, wherein the vibration sensing unit comprises at least one of an accelerometer or a gyroscope.

4. The computing device of claim 2, wherein the acoustic sensing unit comprises one or more microphones.

5. The computing device of claim 1, wherein upon determination that the button has been depressed, the processing unit generates a corresponding control signal.

6. The computing device of claim 1, wherein the mechanical interface unit is configured to provide a tactile feedback to a user when the button is depressed.

7. The computing device of claim 2, further comprising:
a plurality of mechanical interface units located on a housing of the mechanical interface unit, wherein each individual mechanical interface unit is configured to generate, when actuated, at least one of: (a) an acoustic signal having a characteristic acoustic pattern or (b) a vibration signal having a characteristic vibration pattern.

8. The computing device of claim 1, wherein the computing device is a head-mountable device (HMD).

9. (canceled)

10. The computing device of claim 1, wherein the computing device comprise a head-mountable device (HMD), wherein the HMD comprises a glasses-style frame, wherein the button is located on a first side arm of the glasses-style frame, and wherein no electric components of the HMD are located on, or electrically connected to, the first side arm.

11. (canceled)

12. The computing device of claim 1, wherein the characteristic vibration pattern is a first characteristic vibration pattern, and wherein the button is further configured, when released after being depressed, to generate a vibration signal having a second characteristic vibration pattern.

13. The computing device of claim 12, wherein the comparison of the received vibration signal data with the characteristic vibration pattern includes comparing a power spectrum of the received vibration signal data with a power spectrum corresponding to the characteristic vibration pattern, and wherein the processing unit is further configured to:
in response to determining that the power spectrum of the vibration signal data substantially matches a power spectrum corresponding to the first characteristic vibration pattern, generate a first control signal; and
in response to determining that the power spectrum of the vibration signal data substantially matches a power spectrum corresponding to the second characteristic vibration pattern, generate a second control signal.

14. The computing device of claim 1, wherein the button is further configured to generate, when depressed, an acoustic signal having a characteristic acoustic pattern, the computing device further comprising:
an acoustic sensing unit configured to detect the acoustic signal and to generate corresponding acoustic signal data.

15. The computing device of claim 14, wherein the characteristic acoustic pattern is a first characteristic acoustic pattern, and wherein the button is further configured, when released after being depressed, to generate an acoustic signal having a second characteristic acoustic pattern.

16. The computing device of claim 1, wherein the processing unit is further configured to initiate a calibration process to adjust the characteristic vibration pattern of the button.

17. A computer-implemented method comprising:
receiving acoustic signal data generated by an acoustic sensing unit of a computing device;
receiving vibration signal data generated by a vibration sensing unit of the computing device, wherein a mechanical interface unit comprises a button that is arranged on the computing device and, when depressed, generates both an acoustic signal having a characteristic acoustic pattern and a vibration signal that propagates through at least one component of the computing device with a characteristic vibration pattern, wherein the button is non-electric and is arranged on the computing device at a location that is electrically isolated; and
determining, based on a comparison of the acoustic and vibration signal data with the characteristic acoustic and vibration patterns generated when the button is depressed, that the button has been depressed.

18. The method of claim 17, wherein the comparison of the acoustic and vibration signal data with the characteristic acoustic and vibration patterns, comprises:
determining a first Fast Fourier Transform (FFT) of the acoustic signal data;
determining a second FFT of the vibration signal data;
combining the first FFT and the second FFT to determine a combined FFT; and
comparing the combined FFT to a predetermined FFT that corresponds to both the characteristic acoustic pattern and the characteristic vibration pattern.

19. A method of claim 17, wherein the comparison of the acoustic and vibration signal data with the characteristic acoustic and vibration patterns comprises:
determining a power spectrum of the received vibration signal data;
determining a power spectrum of the received acoustic signal data; and wherein the determination that the button has been depressed is based on both: (i) a comparison of the power spectrum of the received vibration signal data with a predetermined power spectrum corresponding to the characteristic vibration pattern, and (ii) a comparison of the power spectrum of the received acoustic signal data with a predetermined power spectrum corresponding to the characteristic acoustic pattern.

20. The method of claim 19, further comprising:
in response to determining that the button has been actuated, generating a corresponding control signal.

21. The method of claim 19, wherein the computing device is a head-mountable device.

22. A non-transitory computer readable medium storing instructions that, when executed by one or more processors in a computing device, cause the computing device to perform operations comprising:
receiving acoustic signal data generated by an acoustic sensing unit of a computing device;
receiving vibration signal data generated by a vibration sensing unit of the computing device, wherein a button is arranged on the computing device and, when depressed, generates both an acoustic signal having a characteristic acoustic pattern and a vibration signal that propagates through at least one component of the computing device with a characteristic vibration pattern, wherein the button is non-electric and is arranged on the computing device at a location that is electrically isolated; and
determining, based on a comparison of the acoustic and vibration signal data with the characteristic acoustic and vibration patterns, that the button has been depressed.

23. The non-transitory computer readable medium of claim 22, wherein the determining that the mechanical interface unit has been actuated includes:
determining a first Fast Fourier Transform (FFT) of the acoustic signal data;
determining a second FFT of the vibration signal data;
combining the first FFT and the second FFT to determine a combined FFT; and
comparing the combined FFT to a predetermined FFT that corresponds to both the characteristic acoustic pattern and the characteristic vibration pattern.

24. The non-transitory computer readable medium of claim 22, wherein the comparison of the acoustic and vibration signal data with the characteristic acoustic and vibration patterns includes:
determining a power spectrum of the received vibration signal data;
determining a power spectrum of the received acoustic signal data; and
wherein the determination that the mechanical interface unit has been actuated is based on both: (i) a comparison of the power spectrum of the received vibration signal data with a predetermined power spectrum corresponding to the characteristic vibration pattern, and (ii) a comparison of the power spectrum of the received acoustic signal data with a predetermined power spectrum corresponding to the characteristic acoustic pattern.

25. The computing device of claim 1, wherein the mechanical interface unit further comprises a button well, wherein the button well is arranged such that depression of the button into the button well generates the characteristic vibration pattern.

26. The computing device of claim 25, wherein at least a portion of an inner surface of the button well comprises a texture, and wherein depression of the button into the button well causes the button to move across the texture and generate the characteristic vibration pattern.
